(19) United States
(12) Patent Application Publication
(10) Pub. No.: US 2006/0271999 A1
(43) Pub. Date: Nov. 30, 2006

(54) Digital data receiver apparatus

(75) Inventors: Takeshi Wakako, Osaka (JP); Takashi Kamada, Osaka (JP); Tomoaki Watahiki, Kanagawa (JP); Hiroyuki Morimoto, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/434,973

(22) Filed: May 16, 2006

(30) Foreign Application Priority Data
May 24, 2005 (JP) 2005-150379
May 9, 2006 (JP) 2006-130598

(51) Int. Cl. H04N 7/16; H04N 7/173

(52) U.S. Cl. 725/135; 725/134

(57) ABSTRACT

A digital data receiver apparatus includes: a view suspend detector that detects a suspend instruction by a user of suspending audio output and video output; and a controller that, when the view suspend detector detects a suspend instruction, controls a data receiver, a demultiplexer, an audio decoder, an audio output unit, a video decoder and a video output unit so that power supplying to or operation of each of these units is stopped in at least two steps. Thereby, power supplying to or operation of the respective units can be stopped step by step after the detection of the view stop instruction. As a result, if the user requests to start viewing within a short time after the view stop request, the viewing can be resumed in a short time period.

### BACKGROUND OF THE INVENTION

1. Field of the Invention

The present invention relates to a digital data receiver apparatus capable of receiving digital data distributed by digital broadcasting.

2. Description of Related Art

Digital broadcasting that provides content composed of pictures, sounds, text and management information as digital streams has been put to practical use gradually. For instance, in addition to BS digital broadcasting and CS digital broadcasting, terrestrial digital broadcasting has started. Further, 1-segment broadcasting having a limited frequency band, exclusively used for receiving with portable terminals, will start in the very near future, whereby the marriage of broadcasting with mobile phones especially is expected. In these digital broadcasting techniques, the MPEG2-TS (Moving Picture Experts Group 2-Transport Stream) is employed as a transmission scheme, which is for multiplexing content such as pictures, sounds and data including text and management information) into one stream for transmission.

Meanwhile, mobile phones increasingly have been equipped with the functions of allowing users to enjoy pictures and sounds by methods different from the digital broadcasting, such as a playback function of motion picture data distributed over the Internet, a motion-picture capturing and playback function using a camera function and a playback function of music data stored in a memory card.

However, such video and audio data have sophisticated coding, so that decoding them for playback consumes a large amount of electric power. Therefore, in the case of a device having a small battery capacity like a portable terminal, power savings are the issues to be addressed.

In a foldable portable terminal disclosed in JP 2002-261888 A, when a user closes the terminal that has been opened for viewing pictures and listening to music, the terminal is controlled to stop the playback of the pictures and music in order to reduce the power consumption. When the terminal is opened again, the playback of pictures and music is started so as to shift to a viewable state. In this way, the convenience of users can be ensured. However, in order to view digital broadcasting, processing such as data-receive processing, demultiplex processing and data-decoding processing has to be carried out successively. Therefore, it takes time before the pictures and sounds are output, following the input of a viewing start instruction. According to the method disclosed in JP 2002-261888 A, when the terminal is closed, the playback operation is stopped, so that it requires considerable time to output the pictures and sounds again, thus degrading the usability.

Further, every time the terminal is opened, the state where no picture is displayed on a display lasts for a long time, and therefore a user might consider erroneously that a glitch has occurred.

Moreover, even when a user does not wish to resume the viewing of digital broadcasting, the viewing always is resumed every time the terminal is opened. Therefore, the user is forced to conduct a viewing stop operation, thus significantly impairing the convenience of users.

### SUMMARY OF THE INVENTION

Therefore, in order to cope with the above-stated problems, it is an object of the present invention to provide a digital data receiver apparatus allowing a user to resume the viewing in a short time period, when the user requests to start the viewing within a short time after a viewing stop request by the user.

In order to solve the above-stated problems, a digital data receiver apparatus of the present invention includes: a data acquisition unit that acquires a data signal; a demultiplexer that demultiplexes the data signal obtained by the data acquisition unit into audio data and video data so as to generate an audio stream and a video stream; an audio decoder that decodes the audio stream generated by the demultiplexer; an audio output unit that outputs sounds obtained by decoding by the audio decoder; a video decoder that decodes the video stream generated by the demultiplexer; a video output unit that outputs pictures obtained by decoding by the video decoder; a view suspend detector that detects a suspend instruction by a user of suspending audio output and video output; and a controller that, when the view suspend detector detects a suspend instruction, controls the data acquisition unit, the demultiplexer, the audio decoder, the audio output unit, the video decoder and the video output unit so that power supplying to or operation of each of these units is stopped in at least two steps.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing the configuration of a digital broadcasting receiver apparatus according to one embodiment of the present invention.

FIG. 2 is a perspective view showing the digital broadcasting receiver apparatus in the open state.

FIG. 3 is a perspective view showing the digital broadcasting receiver apparatus in the closed state.

FIG. 4 is a flowchart of a view stop sequence.

FIG. 5 is a flowchart of a view stop sequence during recording.

FIG. 6 is a flowchart of a view stop sequence.

FIG. 7 is a flowchart of a view start sequence.

FIG. 8 is a flowchart showing activation and initialization processing of a signal receiver.

FIG. 9 is a flowchart showing activation and initialization processing of a demultiplexer.

FIG. 10 is a flowchart showing activation and initialization processing of a video decoder.

FIG. 11 is a flowchart showing activation and initialization processing of an audio decoder.

FIG. 12 is a plan view showing the appearance of a digital broadcasting receiver apparatus of Embodiment 2.

FIG. 13 is a flowchart showing a view hold sequence.

FIG. 14 schematically shows functions of a mobile phone terminal of Embodiment 3.

FIG. 15 is a flowchart showing a stop processing of a TV viewing function and a camera function.

FIG. 16 is a perspective view showing the appearance of a digital broadcasting receiver apparatus.

### DETAILED DESCRIPTION OF THE INVENTION

In the digital data receiver apparatus of the present invention, the controller may control the respective units as follows: upon detection of a suspend instruction by the view suspend detector, power supplying to or operation of the audio output unit and the video output unit is stopped, when n1 seconds has elapsed from the detection of the suspend instruction by the view suspend detector, power supplying to or operation of the audio decoder and the video decoder is stopped, when n2 seconds has elapsed from the detection of the suspend instruction by the view suspend detector, power supplying to or operation of the demultiplexer is stopped, and when n3 seconds has elapsed from the detection of the suspend instruction by the view suspend detector, power supplying to or operation of the data acquisition unit is stopped.

Further, in the above controller, n1, n2 and n3 may have the relationship of n1<n2<n3.

The above digital data receiver apparatus further may include a view hold detector that detects a continuing instruction by the user so as to continue audio output and sound output. When the view hold detector detects a continuing instruction during a time period of n seconds from detection of a suspend instruction by the view suspend detector, power supplying to or operation of the data acquisition unit, the demultiplexer, the audio decoder, the audio output unit, the video decoder and the video output unit may be stopped partially. With this configuration, when a view suspend request is issued, the portions to be stopped can be changed easily in accordance with the viewing condition of the user.

The above digital data receiver apparatus further may include a stream storage unit that stores temporarily the video stream generated by the demultiplexer during stopping of power supplying to or operation of the audio decoder.

In the above configuration, the video stream stored in the stream storage unit may be a head picture only.

In the above digital data receiver apparatus, when a view start instruction is input, the controller may control the respective units as follows: if operation of the data acquisition unit is stopped, the data acquisition unit is activated, if operation of the demultiplexer is stopped, the demultiplexer is activated, if operation of the video decoder and the audio decoder is stopped, the video decoder and the audio decoder are activated, and if operation of the video output unit and the audio output unit is stopped, the video output unit and the audio output unit are activated. With this configuration, since the respective units are activated in the reversed order of the view stop processing, there is no need to activate the circuits that already have been activated, and therefore pictures and sounds can be output quickly.

The above digital data receiver apparatus further may include an additional function execution unit capable of executing an additional function. The controller may control the respective units as follows: if an instruction of activating the additional function execution unit is input when received digital data is output from the video output unit and the audio output unit, operation of the video output unit and the audio output unit is stopped and the additional function is executed, and if a view start instruction is input before a predetermined time period has elapsed after the stopping of the operation of the video output unit and the audio output unit, the additional function execution unit is stopped and the video output unit and the audio output unit are activated. With this configuration, when data is received as background processing during the execution of an additional function, wasted power consumption can be reduced.

According to the digital data receiver apparatus of the present invention, power supplying to or operation of the respective units can be stopped step by step after the detection of a view stop instruction. Therefore, if a user requests to start viewing within a short time after the view stop request, the viewing can be resumed in a short time period.

### Embodiment 1

1. Configuration of a Digital Broadcasting Receiver Apparatus

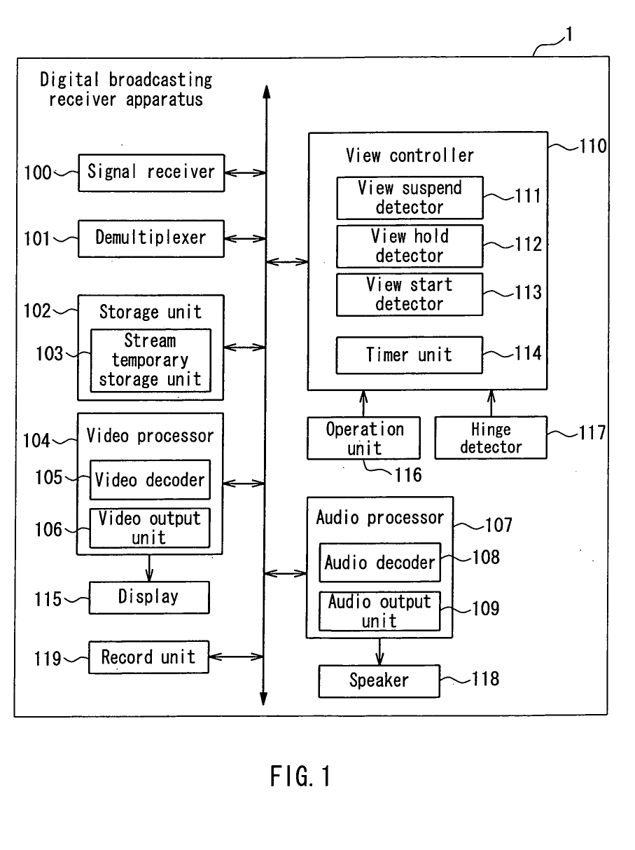

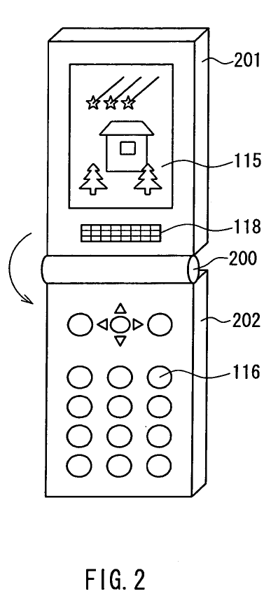

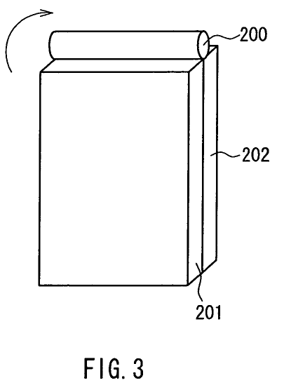

FIG. 1 is a block diagram showing the configuration of a digital broadcasting receiver apparatus of Embodiment 1. FIG. 2 and FIG. 3 are perspective views showing the external configuration of the digital broadcasting receiver apparatus.

The digital broadcasting receiver apparatus of the present embodiment is one example of a digital data receiver apparatus. The digital data receiver apparatus preferably is configured with a portable terminal, and for example may be configured with a mobile phone capable of receiving digital broadcasting as shown in FIG. 2 and FIG. 3. Note here that the apparatus equipped with the digital broadcasting receiver apparatus is not limited to a mobile phone, and PDA (Personal Digital Assistants), lap-top personal computers, vehicle-mounted navigation systems and the like are possible. Further, the apparatus of the present embodiment is not limited to a receiver apparatus capable of receiving terrestrial digital broadcasting, and it may be a receiver apparatus capable of receiving radio broadcasting (e.g., terrestrial digital audio broadcasting) and a receiver apparatus capable of receiving pictures and sounds via a network.

As shown in FIG. 1, the digital broadcasting receiver apparatus is composed of a signal receiver 100, a demultiplexer 101, a storage unit 102, a video processor 104, an audio processor 107, a controller 110 and a record unit 119. These units are connected via buses so as to allow the mutual transmission of data. A display 115 further is connected with the video processor 104, and an operation unit 116 and a hinge detector 117 are connected with the controller 110. A speaker 118 is connected with the audio processor 107.

The signal receiver 100 is capable of receiving data such as from digital broadcasting, and is composed of an antenna, a tuner and the like. In the case where 1-segment broadcasting is received as in the present embodiment, this unit may be composed of an OFDM (Orthogonal Frequency Division Multiplexing) demodulator, a tuner and the like for 1-segment broadcasting. The signal receiver 100 outputs a MPEG2-TS multiplexed stream. Note here that in the present embodiment the signal receiver 100 may have any configuration as long as it is a means for receiving digital broadcasting. Therefore, this may be for example a wireless LAN (Local Area Network) for distributing motion pictures and an Internet connection means such as a PHS (Personal Handy-phone System). Furthermore, the broadcasting that the signal receiver 100 can receive is not limited to terrestrial digital television broadcasting, and this may be radio broadcasting and data broadcasting.

The demultiplexer 101 performs demultiplex processing of the MPEG2-TS multiplexed stream output from the signal receiver 100 so as to obtain a video stream, an audio stream and a data stream.

The storage unit 102 can temporarily store a stream and various data when data is processed in the respective units of the apparatus. The storage unit 102 further includes a stream temporary storage unit 103 that can store temporarily a video stream, for example. The storage unit 102 is composed of SDRAM (Synchronous Dynamic Random Access Memory), for example.

The video processor 104 is composed of a video decoder 105 and a video output unit 106. The video decoder 105 decodes the video stream subjected to demultiplexing so as to generate video data (e.g., MPEG2 video data and H.264 video data). In the present embodiment, since a MPEG2-TS multiplexed stream is received, decode processing complying with the MPEG2 format is conducted. The video output unit 106 modulates the video data decoded by the video decoder 105 into a video signal that can be displayed on a display 115. For instance, in the case where the display 115 is composed of a display compatible with the NTSC format, the video output unit 106 is composed of a NTSC encoder. The picture output unit 106 further includes LSI (Large Scale Integration) for a display controller, a NTSC encoder and the like.

The display 115 can display the video signal output from the video processor 104. The display 115 for example may be composed of a liquid crystal display, an EL (Electro-Luminescence) display, a plasma display, a head mount display or the like. The display 115 can display various information in addition to the video signal.

The audio processor 107 is composed of an audio decoder 108 and an audio output unit 109, and the speaker 118 is connected thereto. The audio decoder 108 decodes the audio stream subjected to the demultiplexing so as to generate audio data. The audio data is in the AAC (Advanced Audio Coding) format, for example. The audio output unit 109 converts the decoded audio data into an audio signal that can be output through the speaker 118. The audio output unit 109 for example is composed of a DA converter that converts a digital signal into an analog signal, whereby digital audio data can be converted into an analog audio signal. The audio output unit 109 further includes LSI for a D/A converter, an amplifier and the like. As a playback device, an integrated speaker, an external speaker, a headphone or the like is available.

The speaker 118 can output the audio signal output from the audio processor 107 as sound. Although the present embodiment is configured so that the sound is output externally through the speaker 118, this may be any configuration that at least allows a user to listen to the sound, and therefore may include a terminal to which earphones can be connected.

The controller 110 includes a view suspend detector 111, a view start detector 113 and a timer unit 114. The operation unit 116 and the hinge detector 117 are connected with the controller 110.

The operation unit 116 is composed of operation buttons that a user can operate, and by operating with these buttons, various functions of the present apparatus can be executed. In the present embodiment, at least an instruction for stopping the viewing of digital broadcasting and an instruction for starting the viewing of the same can be input and executed.

In the case where the present apparatus is configured with a foldable portable terminal as shown in FIG. 2 and FIG. 3, the hinge detector 117 is built in its hinge part 200. Then, the hinge detector 117 outputs different detection signals when the present apparatus is in the open state as shown in FIG. 2 and in the closed state as shown in FIG. 3.

The view suspend detector 111 enables the control of the present apparatus so that the receiving of digital broadcasting or the output of pictures/sounds is suspended when a view stop instruction is input through the operation unit 116 (for example, the operation of an “off” button in the case of a mobile phone) or when the hinge detector 117 detects the shift to the closed state of the apparatus. However, the view suspend detector 111 can detect the view suspend operations based on information from units other than the operation unit 116 and the hinge detector 117. For instance, as a possible configuration, the view suspend may be instructed using a menu displayed on the display 115.

The view start detector 113 enables the control of the present apparatus so that the receiving of digital broadcasting or the output of pictures/sounds is started when a view start instruction is input through the operation unit 116 (for example, the operation of a button exclusive to the viewing start) or when the hinge detector 117 detects the shift to the open state of the apparatus.

The timer unit 114 counts the elapsed time from the respective processing steps during the view suspend processing. The detailed function of this unit will be described later.

Video/audio data of the digital broadcasting received by the present apparatus can be recorded in the record unit 119. The record unit 119 is composed of a hard disk drive, an optical disk or a memory card, for example. The data recorded in the record unit 119 may be video data decoded by the video decoder 105, audio data decoded by the audio decoder 108, video/audio streams output from the demultiplexer 101, a stream prior to the demultiplex processing and the like.

In the present embodiment, the controller 110 is provided with the timer unit 114. However, each of the video processor 104 and the audio processor 107 may be provided with a timer unit exclusive thereto.

Further, PES (Packetized Elementary Stream) stored in the stream temporary storage unit 103 may be a video PES only. Alternatively, this may be a head picture only, instead of PES.

2. Operations of View Suspend Processing

The following describes the view suspend procedure by the controller 110. The controller 110 is provided with a view suspend detector 111 that detects an operation by a user for suspending the view. In the following, an example is described where the view suspend detector 111 is an open/close detector that detects the closing of an apparatus whose display portion is foldable. FIG. 2 and FIG. 3 show the appearance of the digital broadcasting receiver apparatus 1 of the present embodiment. The digital broadcasting receiver apparatus 1 in this case includes a first enclosure 201 with the display 115 and the speaker 118 provided thereon and a second enclosure 202 with the operation unit 116 provided thereon, where the first enclosure 201 and the second enclosure 202 are coupled so that they can be opened and closed around the hinge 200.

As shown in FIG. 2, when the present apparatus is open, the display 115 is viewable externally, and the speaker 118 also is exposed to the outside. Also, the operation unit 116 is operable by a user. When digital broadcasting is received in this state, pictures of the digital broadcasting are displayed on the display 115, and sounds are output through the speaker 118. A viewer can view the pictures and listen to the sounds while selecting channels and adjusting a sound level by operating the operation unit 116.

During viewing the digital broadcasting, when the viewer intends to suspend or stop the viewing, an instruction for suspending or stopping the viewing may be input by operating with the operation unit 116 or the first enclosure 201 may be rotated in the direction of the arrow so as to shift the apparatus to the state of FIG. 3. In the state of FIG. 3, none of the display 115, the speaker 118 and the operation unit 116 is exposed to the exterior, and the output of pictures and sounds is stopped.

The present apparatus further is provided with a recording function, by which video/audio data of the digital broadcasting received can be recorded in the record unit 119. Whether the present apparatus is in the open state or the closed state, the recording function can be executed. When the present apparatus is opened during the recording, the pictures of the recorded contents are displayed on the display 115 and the sounds of the recorded contents are output through the speaker 118.

The following describes the view suspend processing more specifically. In the following, the view suspend processing to be conducted when the state of the present apparatus is shifted from FIG. 2 to FIG. 3 is explained.

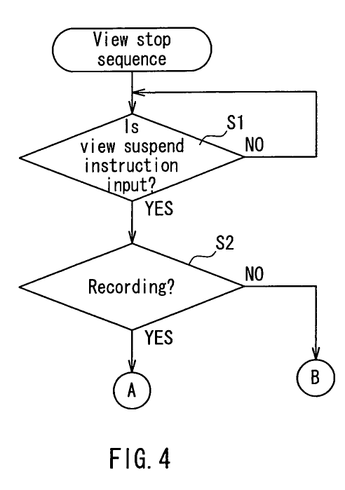

FIG. 4 shows the basic flow of the view suspend processing. In FIG. 4, the view suspend detector 111 monitors the state of the hinge detector 117 and detects the open/close state of the present apparatus based on a detection signal output from the hinge detector 117 (Step S1).

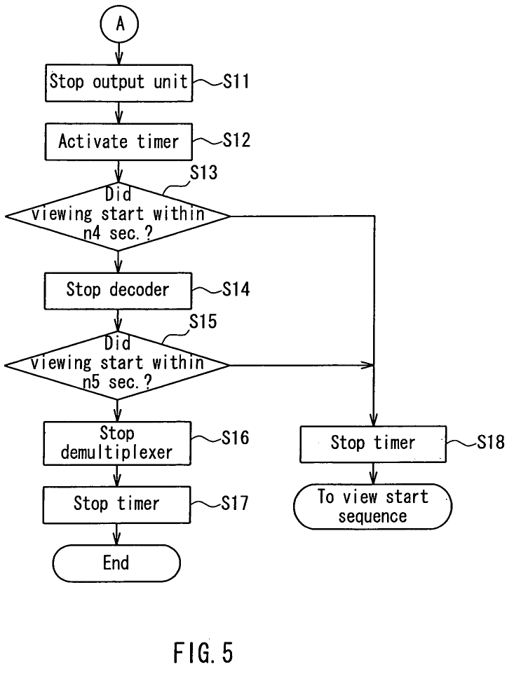

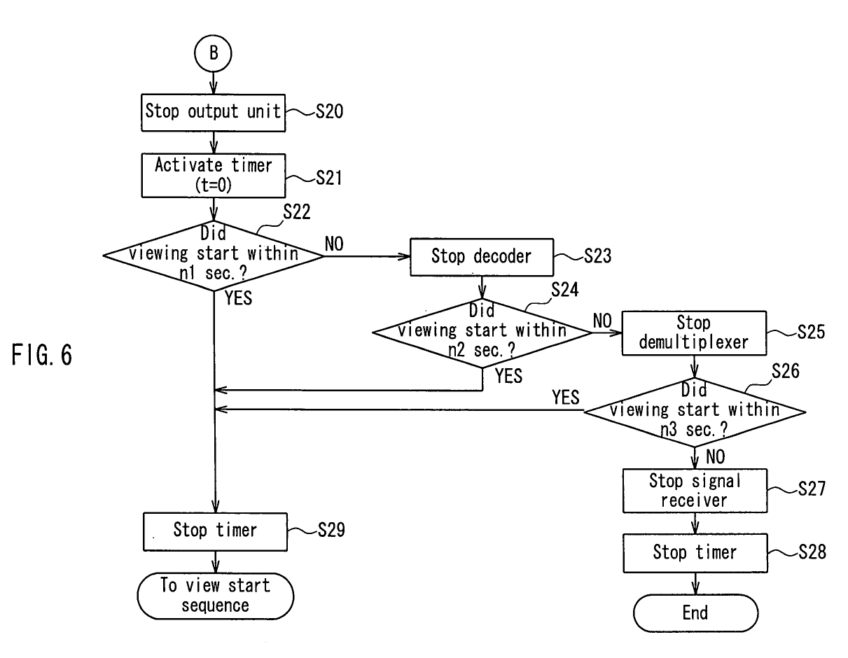

When the present apparatus is closed during the viewing, the view suspend detector 111 detects that the apparatus is closed based on a detection signal from the hinge detector 117. Next, confirmation is conducted as to whether the apparatus is recording content or not (Step S2). If the apparatus is recording some content, the process goes to the sequence of FIG. 5, and if the apparatus is not recording content but only viewing is performed, the process goes to the sequence of FIG. 6.

2-1. View Stop Sequence During Recording

FIG. 5 is a flowchart showing the view stop sequence during recording. When a view stop instruction is input during recording, the operation of the video output unit 106 is stopped firstly so as to stop the video output to the display 115. Further, the operation of the audio output unit 109 is stopped so as to stop the audio output to the speaker 118 (Step S11).

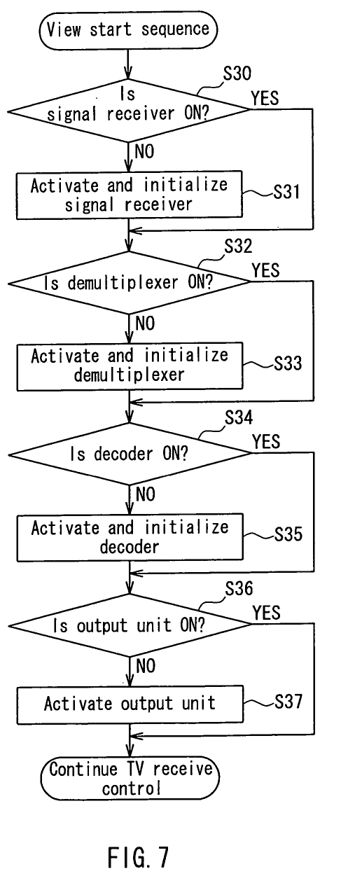

When the video/audio output stops, the timer unit 114 starts counting (Step S12). If a view start instruction is input before the counter value of the timer unit 114 reaches n4 seconds (Step S13), the operation of the timer unit 114 is stopped (Step S18) and the process goes to the view start sequence (see FIG. 7). The view start instruction can be input by shifting the present apparatus from the state of FIG. 3 to the state of FIG. 2 or by operating the operation unit 116.

At Step S13, if a view start instruction is not input within n4 seconds, the operation of the video decoder 105 and the audio decoder 108 is stopped (Step S14).

Next, if a view start instruction is input before the counter value of the timer unit 114 reaches n5 seconds (Step S15), the operation of the timer unit 114 is stopped (Step S18) and the process goes to the view start sequence (see FIG. 7).

At Step S15, if a view start instruction is not input within n5 seconds, the operation of the demultiplexer 101 is stopped (Step S16) and at the same time the operation of the timer unit 114 is stopped (Step S17). Therefore, when the process reaches Step S17, the operation of the video processor 104, the audio processor 107, the demultiplexer 101 and the display 115 has been stopped.

Note here that during the processing of the above sequence, the recording operation is continued without stopping. Further, also at Step S17 or later, the recording operation will be continued. In order to stop the recording operation, a predetermined recording stop operation may be conducted, or in the case of timer recording, the apparatus is controlled so that the recording can be finished automatically at the recording completion time.

The values of n4 and n5 are arbitrary, and preferably the relationship of n4<n5 is satisfied. The values of n4 and n5 may be set at least larger than 0. Smaller values allow the operation of the respective circuits to be stopped earlier, so as to reduce power consumption. However, in this case, the number of the circuits requiring the activation operation at the start of the viewing is increased, and therefore it takes time before pictures and sounds are output following the input of a view start instruction. On the other hand, larger values of n4 and n5 reduce the number of the circuits requiring the activation operation at the start of the viewing, and therefore the time required to output pictures and sounds following the input of a view start instruction can be shortened.

FIG. 5 shows the sequence where a stream before demultiplexing is recorded in the record unit 119.

2-2. View Stop Sequence

FIG. 6 shows a control flow by the controller 110 when a view stop instruction is input during viewing (e.g., when the apparatus is closed).

In FIG. 6, when a view stop instruction is input during the viewing of digital broadcasting, firstly, electricity fed to the video output unit 106 and the audio output unit 109 is stopped so as to stop their operation (Step S20).

Next, the timer unit 114 is activated so as to start the counting (Step S21). If the resumption of the viewing is not detected by the view start detector 113 within n1 seconds from the start of the counting by the timer unit 114 (Step S22), the video decoder 105 and the audio decoder 108 are stopped (Step S23).

Next, if the resumption of the viewing is not detected by the view start detector 113 within n2 seconds from the start of the counting by the timer unit 114 (Step S24), the demultiplexer 101 is stopped (Step S25). Note here that since the demultiplexer 101 operates until n2 seconds, audio PES and video PES can be obtained continuously during this time period. The audio PES and video PES obtained during this time period are stored in the stream temporary storage unit 103.

Next, if the resumption of the viewing is not detected by the view start detector 113 within n3 seconds from the start of the counting by the timer unit 114 (Step S26), the signal receiver 100 is stopped (Step S27) and the timer is stopped (S28). Therefore, at the stage of Step S28, the operation of all of the units other than the view start detector 113 in FIG. 1 has been stopped.

If a view start instruction is input within n1 to n3 seconds at Steps S22, S24 and S26, the operation of the timer unit 114 is stopped (Step S29) and the process goes to the view start sequence (see FIG. 7).

Note here that since the video decoder 105 and the audio decoder 108 operate until n1 seconds, the decoded results of these units may be stored in the stream temporary storage unit 103.

The values of n1, n2 and n3 are arbitrary, and preferably the relationship of n1<n2<n3 is set. The values of n1, n2 and n3 may be set at least larger than 0. Smaller values allow the operation of the respective circuits to be stopped earlier, so as to reduce power consumption. However, in this case, the number of the circuits requiring the activation operation at the start of the viewing is increased, and therefore it takes time before pictures and sounds are output, following the input of a view start instruction. On the other hand, larger values of n1 to n3 reduce the number of the circuits requiring the activation operation at the start of the viewing, and therefore the time required to output pictures and sounds, following the input of a view start instruction, can be shortened.

In the present embodiment, although upon detection of the view suspend by the view suspend detector 111, the operation of the video output unit 106 and the audio output unit 109 is stopped (Step S20), this may be controlled so as to stop their operation after any m seconds have elapsed.

3. Operations of View Start Processing

3-1. View Start Sequence

When the digital broadcasting receiver apparatus 1 is activated by a user's operation of a power supply switch at the operation unit 116, when channels are changed by pushing a channel button at the operation unit 116, or when the apparatus is shifted from the closed state (see FIG. 3) to the open state (see FIG. 2), the view start detector 113 of the controller 110 detects a view start instruction, and the controller 110 starts the view control. The view control by the controller 110 is executed by software control by means of a CPU (Central Processing Unit), for example.

In the following description, “activation” refers to the operation of turn-on or setting when the respective steps are executed by hardware processing. When they are executed by software processing, “activation” refers to the start of the processing.

FIG. 7 is a flowchart showing the view start sequence executed by the controller 110. Firstly, when a view start instruction is input, confirmation is conducted as to whether the signal receiver 100 is activated or not (Step S30). If the signal receiver 100 is activated, the process goes to Step S32. On the other hand, if the signal receiver 100 is not activated, activation processing and initialization processing of the signal receiver 100 are executed (Step S31), and then the process goes to Step S32.

Next, confirmation is conducted as to whether the demultiplexer 101 is activated or not (Step S32). If the demultiplexer 101 is activated, the process goes to Step S34. On the other hand, if the demultiplexer 101 is not activated, activation processing and initialization processing of the demultiplexer 101 are executed (Step S33), and then the process goes to Step S34.

Next, confirmation is conducted as to whether the video decoder 105 and the audio decoder 108 are activated or not (Step S34). If the video decoder 105 and the audio decoder 108 are activated, the process goes to Step S36. On the other hand, if the video decoder 105 and the audio decoder 108 are not activated, activation processing and initialization processing of the video decoder 105 and the audio decoder 108 are executed (Step S35), and then the process goes to Step S36.

Next, confirmation is conducted as to whether the video output unit 106 and the audio output unit 109 are activated or not (Step S36). If the video output unit 106 and the audio output unit 109 are activated, the view start sequence ends. On the other hand, if the video output unit 106 and the audio output unit 109 are not activated, activation processing of the video output unit 106 and the audio output unit 109 is executed (Step S37), and then the view start sequence ends. Note here that in the present embodiment when a view stop instruction is input, the video output unit 106 and the audio output unit 109 always are stopped as shown in FIG. 5 and FIG. 6 (Steps S11, S21), and therefore Step S36 of FIG. 7 may be omitted.

In this way, in the view start sequence, the respective units are activated and initialized in the reversed order of the stop processing in the view stop sequence of FIG. 5 and FIG. 6.

With such a sequence, the shorter the time between the input of a view stop instruction and the input of a view start instruction, the shorter time required to output pictures and sounds becomes.

That is, conventionally, when a view stop instruction is input, all of the processors are stopped almost at the same time. Therefore, when a view start instruction is input, all of the processors always have to be activated. On the other hand, according to the present embodiment, the processors can be stopped step by step when a view stop instruction is input, whereby when a view start instruction is input, only the processors that are not activated at that time can be activated, which means that there is no need to activate all of the processors.

For instance, in the case where a view start instruction is input within n4 seconds at Step S13 of FIG. 5, or in the case where a view start instruction is input within n1 seconds at Step S22 of FIG. 6, the processing of Step S37 of FIG. 7 only is executed, so that pictures and sounds of the digital broadcasting received are output. In the case where a view start instruction is input within n5 seconds at Step S15 of FIG. 5, or in the case where a view start instruction is input within n2 seconds at Step S24 of FIG. 6, the processing of Steps S35 and S37 of FIG. 7 is executed, so that pictures and sounds are output. In the case where a view start instruction is input within n3 seconds at Step S26 of FIG. 6, the processing of Steps S33, S35 and S37 of FIG. 7 is executed, so that pictures and sounds are output.

Note here that, in the sequence of FIG. 7, the processing of the video decoder 105 and the audio decoder 108 (Steps S34, S35) and the processing of the video output unit 106 and the audio output unit 109 (Steps S36, S37) are executed independently and in this stated order. However, such processing can be executed together for the activation processing and the initialization processing. In such a case, following the processing of Step S33, the processing of confirming whether the video processor 104 and the audio processor 107 are activated or not and the activation processing and the initialization processing of the video processor 104 and the audio processor 107 may be executed.

3-2. Activation and Initialization of Signal Receiver 100

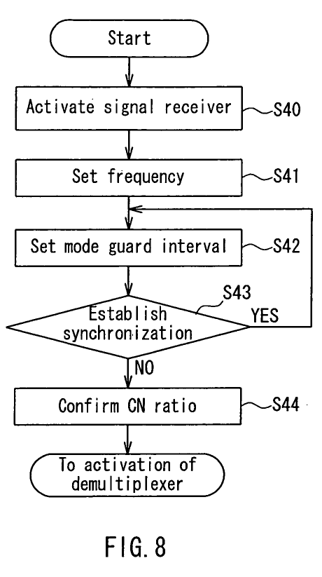

FIG. 8 is a flowchart showing the activation and initialization sequence of the signal receiver 100, which shows the detailed processing of Step S31 of FIG. 7. The following shows the operation where the signal receiver 100 is composed of an OFDM demodulator and a tuner for 1-segment broadcasting.

In FIG. 8, firstly, the controller 110 supplies the signal receiver 100 with electric power so as to activate it (Step S40). Next, a user operates the operation unit 116 so as to set the frequency corresponding to the selected channel (Step S41). Next, a mode guard interval is set (Step S42). This value is different based on conditions of stations provided or a service image, and therefore the optimum value should be detected. When the mode guard interval can be optimized, confirmation is conducted as to whether the synchronization is established or not (Step S43). If the synchronization is not confirmed, another mode guard interval is set (Step S42), and then the confirmation is conducted again (Step S43). After the synchronization is established, a CN ratio (Carrier to Noise Ratio) is confirmed (Step S44). If the ratio is a threshold value or more, the control of the signal receiver 100 is completed.

The MPEG2-TS multiplexed stream received through the above-stated sequence is transmitted to the demultiplexer 101.

Note here that Steps S42 and S43 in FIG. 8 are not essential processes.

3-3. Activation and Initialization of Signal Receiver 100

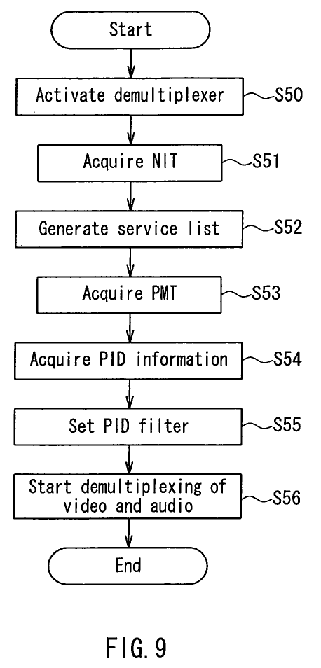

FIG. 9 is a flowchart showing the activation and initialization sequence of the demultiplexer 101. FIG. 9 shows the detailed processing of Step S33 of FIG. 7, which is the demultiplex control for demultiplexing the received MPEG2-TS multiplexed stream and selecting a service.

In FIG. 9, the controller 110 firstly activates the demultiplexer 101 (Step S50). Next, the demultiplex is started and PSI (Program Specific Information) and SI (Specific Information) are acquired from data called a section. Furthermore, among tables defined by the PSI, NIT (Network Information Table) indicating a relationship between information on a transmission path and the program contents is acquired (Step S51).

Next, based on the acquired NIT, a viewable service list is formed (Step S52). Next, PMT (Program Map Table) specifying PIDs (Packet IDs) of the coded signals constituting the program is acquired (Step S53), and based on the acquired PMT, PIDs are acquired (Step S54). The thus formed service list and the acquired PIDs are stored in the storage unit 102.

Next, among the PIDs, in order to acquire PIDs relating to the service selected by a user, a PID filter is set. The target service is selected among a plurality of services, whereby the control is completed (Step S55).

When the PID filter has been set, the controller 110 can acquire a PES (Packetized Elementary Stream) containing the target video and audio ES (Elementary Stream). Therefore, the video ES and the audio ES are fetched from a video/audio PES and output (Step S56).

In the case of 1-segment broadcasting, video data is coded by a coding scheme complying with the H.264 standard, and this coding scheme utilizes motion compensation inter-frame prediction. The motion compensation inter-frame prediction refers to a compressive method, in which an image close to the original image can be reproduced from frame-images along the time axis based on a difference between the information about the previous image and the predicted image for the next image with consideration given to the motion of a subject. In order to decode video data compressed by the motion compensation inter-frame prediction, an IDR (Instantaneous Decoding Refresh) picture showing data coded using the information on that image only, i.e., independent of the previous and subsequent images, must be used. Although an IDR picture is transmitted periodically, no picture can be output until the IDR picture is acquired. In the present embodiment, the thus independently coded data is referred to as a “head picture”.

Note here that in FIG. 9 Steps S51, S52 and S53 are not essential processes

3-4. Activation and Initialization of Video Decoder 105

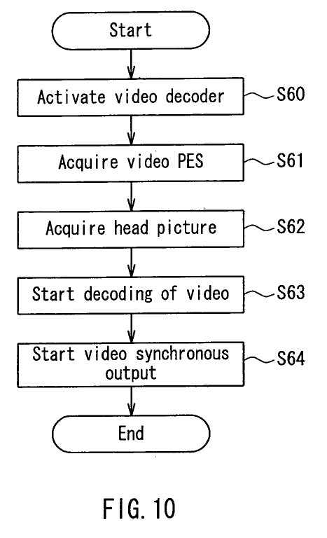

FIG. 10 is a flowchart showing the activation and initialization sequence of the video decoder 105. Note here that FIG. 10 shows the decode processing of video data at Step S35 of FIG. 7.

In FIG. 10, the video processor 104 firstly activates the video decoder 105 (Step S60). Herein, the “activation” refers to the operation of turn-on or setting when the decoding by the video decoder 105 is executed by hardware processing. When it is executed by software processing, the “activation” refers to the start of the processing.

Next, the video PES obtained by the demultiplex control (see FIG. 9) is acquired (Step S61) and the unit is kept in the stand-by mode until a head picture is acquired. When the head picture is acquired (Step S62), the video decoder 105 starts the video decoding processing (Step S63). Next, following the decoding, video synchronous output is started in accordance with PTS (Presentation Time Stamp) (Step S64).

As a result of the above-stated processing, the video decoder 105 can output the decoded video data to the video output unit 106.

3-5. Activation and Initialization of Audio Decoder 108

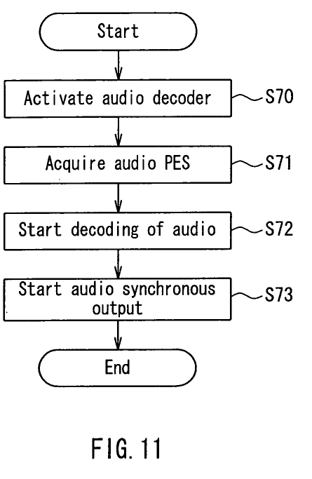

FIG. 11 is a flowchart showing the activation and initialization sequence of the audio decoder 108. Note here that FIG. 11 shows the decode processing of audio data at Step S35 of FIG. 7.

In FIG. 11, the audio processor 107 firstly activates the audio decoder 108 (Step S70). Herein, the “activation” refers to the operation of turn-on or setting when the audio decoder 108 performs hardware processing. In the case of software processing, the “activation” refers to the start of the processing.

Next, the audio PES obtained by the demultiplex control (see FIG. 7) is acquired (Step S71). When audio ES is acquired from the thus acquired audio PES, the audio decoder 108 starts the audio decoding processing (Step S72). Next, following the decoding, audio synchronous output is started in accordance with PTS (Presentation Time Stamp) (Step S73).

As a result of the above-stated processing, the audio decoder 108 can output the decoded audio data to the audio output unit 109.

4. Summary

As stated above, according to the digital broadcasting receiver apparatus of the present invention, the stop processing is executed step by step when the view suspend is detected. Thereby, in the case where a view start instruction is detected in a short time period after the detection of the view suspend, the viewing of television can be resumed in a short time period. For instance, a user may want to suspend the viewing for getting on and off train, and the convenience of the user can be enhanced in such a case.

### Embodiment 2

Embodiment 2 is configured so that the controller 110 of the digital broadcasting receiver apparatus of Embodiment 1 shown in FIG. 1 further includes a view hold detector 112 that detects an instruction of holding the viewing (i.e., not stopping the respective units but making them standby).

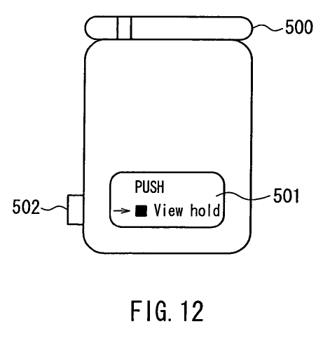

FIG. 12 is a plan view showing the appearance of a digital broadcasting receiver apparatus of Embodiment 2. Similarly to the apparatus shown in FIG. 2 and FIG. 3, the digital broadcasting receiver apparatus of FIG. 12 includes a first enclosure with a display 115 provided thereon and a second enclosure with an operation unit 116 provided thereon, where the first enclosure and the second enclosure can be opened and closed around a hinge 500. When the apparatus is closed as shown in FIG. 12, it is regarded as the input of a view stop instruction by a user. The present apparatus further is provided with a hold button 502 on the side face of the enclosure, and the view hold detector 112 can detect the pressing of the hold button 502. When the hold button 502 is pressed, it is regarded as the input of a view hold instruction by the user. The apparatus further may be provided with a sub-display 501. Descriptions concerning the hold button 502 may be displayed on the sub-display 501, which allows a user clearly to know the functions of the hold button 502. The position of the hold button 502 placed is not limited to the side face of the enclosure. When the digital broadcasting is viewed, the view hold function is assigned to the hold button 502. However, when the digital broadcasting is not received, other functions may be assigned to the hold button 502.

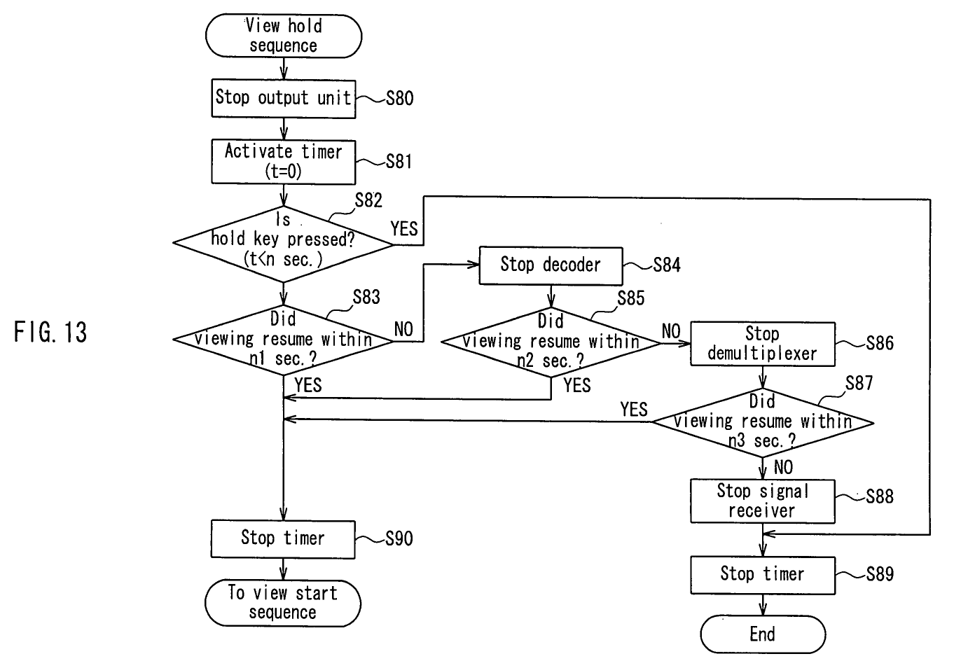

FIG. 13 is a flowchart showing the view hold sequence when the apparatus is closed during the viewing. In the following description, when a hinge detector 117 detects that the apparatus is closed, a view suspend detector 111 detects the view suspend.

When the apparatus is closed during viewing, and the view suspend detector 111 detects a view stop instruction, electricity fed to a video output unit 106 and an audio output unit 109 is stopped so as to stop their operation (Step S80).

Next, a timer unit 114 is activated (Step S81). If the hold button 502 (see FIG. 12) is operated within n seconds after the activation of the timer unit 114 and a view hold instruction is detected by the view hold detector 112 (Step S82), the operation of the timer unit 114 is stopped (Step S89) and the view hold sequence ends. That is, the apparatus is in the state where only the video output unit 106 and the audio output unit 109 are stopped. At the start of the viewing, the processing is performed based on the view start sequence of FIG. 7. Herein, since only the video output unit 106 and the audio output unit 109 are stopped after pushing the hold button 502, Step S37 of FIG. 7 only is executed so as to output pictures and sounds.

At Step S82, if a view hold instruction is not detected within n1 seconds and a view start detector 113 does not detect a view start instruction within n1 seconds (Step S703), a video decoder 105 and an audio decoder 108 are stopped (Step S84). On the other hand, if a view start instruction is input within n1 seconds, the timer unit 114 is stopped (Step S90), and the process goes to the view start sequence (see FIG. 7).

Next, if the view start detector 113 does not detect view resumption within n2 seconds after the activation of the timer unit 114 (Step S85), a demultiplexer 101 is stopped (Step S86). On the other hand, if a view start instruction is input within n2 seconds, the timer unit 114 is stopped (Step S90) and the process goes to the view start sequence (see FIG. 7).

Next, if the view start detector 113 does not detect view resumption within n3 seconds after the activation of the timer unit 114 (Step S87), a signal receiver 100 is stopped (Step S88) and the timer unit 114 is stopped (Step S89). On the other hand, if a view start instruction is input within n3 seconds, the timer unit 114 is stopped (Step S90) and the process goes to the view start sequence (see FIG. 7).

Note here that the order of the view hold detection processing by the view hold detector 112 (Step S82) and the processing of stopping the decoder, the demultiplexer and the signal receive (S84, S86 and S88) is not limited to the order shown in FIG. 13. In this case, the portions stopped before the view hold detection may be restarted, whereby the return processing conducted when the view resumption is detected can be speeded up.

More preferably, in the case where the viewing is not resumed for a long time after the detection of the view hold by the view hold detector 112, or in the case where a user forgets to input a resumption instruction, other portions are stopped.

In this way, according to the digital broadcasting receiver apparatus of Embodiment 2, the view can be held when the apparatus is closed. Thereby, pictures and sounds can be output quickly when the viewing is resumed.

That is, in Embodiment 1, when a view stop instruction is input, the apparatus is controlled so that the respective processors are stopped step by step. On the other hand, in Embodiment 2, following the input of a view stop instruction, the hold button 502 is operated so that the operation of the video output unit 106 and the audio output unit 109 only is stopped so as not to execute the view stop sequence. Especially in the case where after a relatively long time period of the viewing suspend, the viewing should be resumed quickly, the configuration of Embodiment 2 can enhance the convenience of a user.

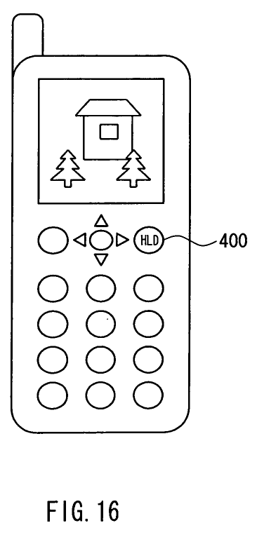

Incidentally, the view suspend detector 111 of the digital broadcasting receiver apparatus 1 of Embodiment 1 and Embodiment 2 may be a key input judgment unit that detects a key input and judges as to whether a key indicating the view suspend is pressed or not. FIG. 16 shows the appearance of the digital broadcasting receiver apparatus 1 when the view suspend detector 111 is a key input judgment unit. In this case, when a suspend key 400 is pressed during the viewing of digital broadcasting, it is regarded as a view stop instruction by a user.

Furthermore, the view suspend detector 111 of the digital broadcasting receiver apparatus 1 of Embodiment 1 and Embodiment 2 may be a configuration where the first enclosure 201 of FIG. 2 is sidable with respect to the second enclosure 202, or a configuration having an open/close cover with which the display 115 on the first enclosure 201 can be covered. In such a case, the controller 110 may detect the sliding motion of the first enclosure 201 and the open/close motion of the open/close cover so as to output a view stop instruction and a view start instruction. Alternatively, the first enclosure 201 may be rotatable with respect to the second enclosure 202 in the plane direction. In such a case, its rotation angle may be detected so as to output a view stop instruction and a view start instruction. In this case, if these motions are detected, they are regarded as a view stop instruction by a user.

### Embodiment 3

The following describes the processing of a mobile phone terminal capable of receiving digital broadcasting, conducted when both of the broadcasting receive function and another function are executed, followed by stopping one of these functions.

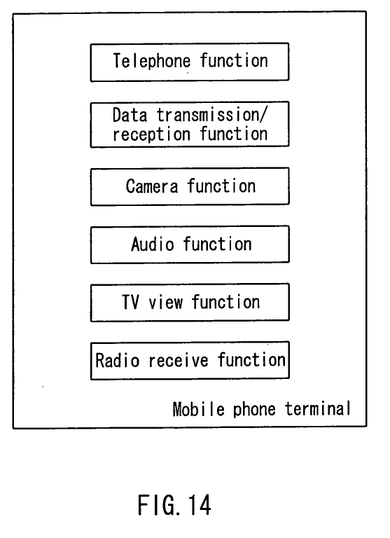

FIG. 14 schematically shows functions of the mobile phone terminal. Since mobile phones have been increasingly versatile in recent years, they are equipped with various functions as shown in this drawing, such as a function as a telephone that enables communication with another mobile phone terminal as well as a stationary telephone, a data transmission/reception function enabling connection with the Internet to browse various sites and e-mail transmission/reception, a camera function enabling taking of photographs using an imaging unit built in the terminal, an audio function enabling the installation of a memory card storing music data and reproduction of the music data, a television viewing function enabling the viewing of television broadcasting as described in Embodiment 1 and Embodiment 2, a radio receiving function enabling the reception of FM radio broadcasting and digital radio broadcasting and the like. Needless to say, these functions can be operated selectively, and moreover a plurality of functions can be executed at the same time by multitask processing. For instance, a user can listen to music using the audio function while performing transmission/reception of Internet mail using the data transmission/reception function.

However, some functions cannot be executed at the same time because of the structural limitation. For instance, the camera function and the television receive function, both of which use the display 115, cannot be executed at the same time.

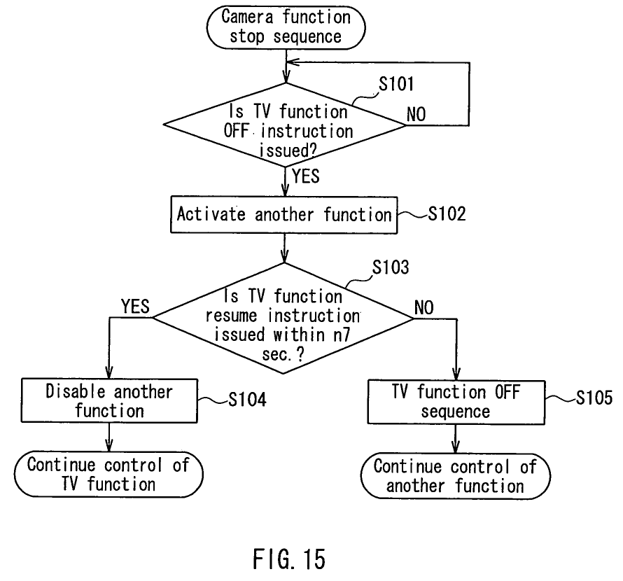

FIG. 15 is a flowchart showing the relationship of the television viewing function and another function (e.g., the camera function). In FIG. 15, when digital broadcasting is viewed using the television viewing function, if a user tries to take a photograph using the camera function, a view stop instruction should be input so as to interrupt the television viewing function (Step S101). When the view stop instruction is input, the timer unit 114 starts counting. When the television viewing function is interrupted, the video output unit 106 and the audio output unit 109 only are stopped. When the television viewing function is interrupted, the camera function can be activated. Thus, the user performs a predetermined operation with the operation unit 116, so as to activate the camera function (Step S102).

Next, when a photograph has been taken using the camera function and the user wants to activate the television viewing function again, the processing follows: that is, if a view start instruction is input within n7 seconds after the view stop instruction (Step S103), the camera function is stopped (Step S104) and the view start sequence of FIG. 7 is executed. As previously described, the video output unit 106 and the audio output unit 109 only are stopped but the signal receiver 100, the demultiplexer 101 and the like remain activated, and therefore pictures and sounds can be output quickly.

On the other hand, if a view start instruction is not input within n7 seconds at Step S103, the view stop sequence (see FIG. 5 or FIG. 6) is executed (Step S105). At this time, the camera function remains activated.

In this way, according to the present embodiment, in the case where the camera function and other functions are activated during the viewing of digital broadcasting using the television viewing function, the television viewing function is kept at standby for a predetermined time period. Therefore, when the television viewing function is resumed, pictures and sounds can be output quickly. That is, when another function is activated, the video output unit 106 and the audio output unit 109 only are stopped but the signal receiver 100, the demultiplexer 101 and the like remain activated. Then, if a view start instruction is input within a predetermined time (n7 seconds), the video output unit 106 and the audio output unit 109 only may be activated, so that pictures and sounds can be output quickly.

On the other hand, if a view start instruction is not input within n7 seconds, the television function may be turned off, whereby wasted power consumption can be reduced.

The present invention is applicable to a digital broadcasting receiver apparatus, and for example, is useful for portable devices such as portable digital broadcasting receive viewers, mobile phone terminals, PDAs, and vehicle-mounted navigation systems.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A digital data receiver apparatus, comprising:
a data acquisition unit that acquires a data signal;
a demultiplexer that demultiplexes the data signal obtained by the data acquisition unit into audio data and video data so as to generate an audio stream and a video stream;
an audio decoder that decodes the audio stream generated by the demultiplexer;
an audio output unit that outputs sounds obtained by decoding by the audio decoder;
a video decoder that decodes the video stream generated by the demultiplexer;
a video output unit that outputs pictures obtained by decoding by the video decoder;
a view suspend detector that detects a suspend instruction by a user of suspending audio output and video output; and
a controller that, when the view suspend detector detects a suspend instruction, controls the data acquisition unit, the demultiplexer, the audio decoder, the audio output unit, the video decoder and the video output unit so that power supplying to or operation of each of these units is stopped in at least two steps.

2. The digital data receiver apparatus according to claim 1,
wherein the controller controls the respective units as follows:
upon detection of a suspend instruction by the view suspend detector, power supplying to or operation of the audio output unit and the video output unit is stopped,
when n1 seconds has elapsed from the detection of the suspend instruction by the view suspend detector, power supplying to or operation of the audio decoder and the video decoder is stopped,
when n2 seconds has elapsed from the detection of the suspend instruction by the view suspend detector, power supplying to or operation of the demultiplexer is stopped, and
when n3 seconds has elapsed from the detection of the suspend instruction by the view suspend detector, power supplying to or operation of the data acquisition unit is stopped.

3. The digital data receiver apparatus according to claim 2, wherein n1, n2 and n3 satisfy the relationship of n1<n2<n3.

4. The digital data receiver apparatus according to claim 1, further comprising a view hold detector that detects a continuing instruction by the user so as to continue audio output and sound output,
wherein when the view hold detector detects a continuing instruction during a time period of n seconds from detection of a suspend instruction by the view suspend detector, power supplying to or operation of the data acquisition unit, the demultiplexer, the audio decoder, the audio output unit, the video decoder and the video output unit is stopped partially.

5. The digital data receiver apparatus according to claim 1, further comprising a stream storage unit that stores temporarily the video stream generated by the demultiplexer during stopping of power supplying to or operation of the audio decoder.

6. The digital data receiver apparatus according to claim 4, further comprising a stream storage unit that stores temporarily the video stream generated by the demultiplexer during stopping of power supplying to or operation of the audio decoder.

7. The digital data receiver apparatus according to claim 5, wherein the video stream stored in the stream storage unit is a head picture only.

8. The digital data receiver apparatus according to claim 6, wherein the video stream stored in the stream storage unit is a head picture only.

9. The digital data receiver apparatus according to claim 1,
wherein when a view start instruction is input, the controller controls the respective units as follows:
if operation of the data acquisition unit is stopped, the data acquisition unit is activated,
if operation of the demultiplexer is stopped, the demultiplexer is activated,
if operation of the video decoder and the audio decoder is stopped, the video decoder and the audio decoder are activated, and
if operation of the video output unit and the audio output unit is stopped, the video output unit and the audio output unit are activated.

10. The digital data receiver apparatus according to claim 1, further comprising an additional function execution unit capable of executing an additional function,
wherein the controller controls the respective units as follows:
if an instruction of activating the additional function execution unit is input when received digital data is output from the video output unit and the audio output unit, operation of the video output unit and the audio output unit is stopped and the additional function is executed, and
if a view start instruction is input before a predetermined time period has elapsed after the stopping of the operation of the video output unit and the audio output unit, the additional function execution unit is stopped and the video output unit and the audio output unit are activated.
